(19) United States
(12) Patent Application Publication
(10) Pub. No.: US 2014/0300784 A1
(43) Pub. Date: Oct. 9, 2014

(54) SYSTEM FOR CAPTURE OF DYNAMIC IMAGES SUCH AS VIDEO IMAGES

(71) Applicant: Sarmat Muratovich Gazzaev, Oktyabr`skoye (RU)

(72) Inventor: Sarmat Muratovich Gazzaev, Oktyabr`skoye (RU)

(21) Appl. No.: 14/283,577

(22) Filed: May 21, 2014

Related U.S. Application Data
(63) Continuation of application No. PCT/RU13/00493, filed on Jun. 14, 2013.

(30) Foreign Application Priority Data
Apr. 3, 2013 (RU) 2013114833

(51) Int. Cl. H04N 5/232; H04N 5/265

(52) U.S. Cl. CPC H04N 5/23238; H04N 5/265
USPC 348/262

(57) ABSTRACT

The proposed invention relates to instrumentation, namely to the optoelectronic systems, and will improve quality of captured images. The proposed system to capture dynamic images includes a set of remote mosaic-located imaging tools and provides the widest viewing angle, as well as a set of image transmission and processing tools to obtain the single image representing the consolidation of the mentioned images. At least one personal portable user tool provides display of this mentioned consolidated image and includes tools to determine the spatial position.

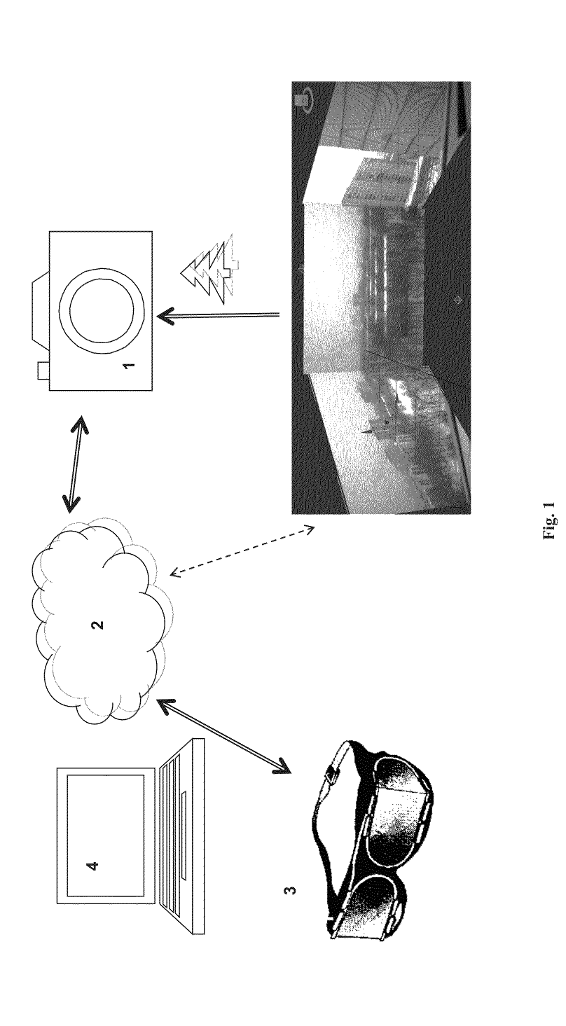

The present invention relates to instrumentation, namely to optoelectronic systems.

There are known optical devices that are used for image capture with the widest viewing angle. For example, from the U.S. Pat. No. 6,361,165 published on 26 Mar. 2002 the eyeglasses are known, which optics provide image capture with the widest viewing angle due to implementation of invertebrate facet eye model. Similar techniques that utilize the above mentioned facet eye principle are used in data acquisition systems to process different information, e.g. see “The Cupola” project description and the description of the optoelectronic system designed by D. Pollok in the article by V. Solomatin, “Faceted vision: perspectives in optoelectronic systems”, “Photonics”, 2009, No. 1. In turn, the present invention is a further development of the above described imaging tools allowing to propose a set of tools that provide dynamic image “delivery” to an individual user in a wide viewing angle. In practical use of the present invention the drawbacks of the U.S. Pat. No. 6,361,165 patent eyeglasses requiring user “presence” in the place of the observed event as well as disadvantages of the above described optoelectronic systems that, in turn, are designed to acquire large enough data arrays without organized communication with technical equipment to be used by an individual user, will be neutralized.

The above technical goal is achieved using the proposed system to capture dynamic images that will primarily be video images including a set of mosaic-located imaging tools that are situated remotely from the user and provide the widest viewing angle, as well as a set of image transmission and processing tools to get the single image representing the consolidation of the mentioned images. At least one personal portable user tool is used to display this mentioned consolidated image. This tool includes tools for spatial positioning. In most cases the personal user tool will be eyeglasses displaying the mentioned consolidated image. The eyeglasses may be used in conjunction with at least one camera provided with at least one viewfinder. In turn, a gyroscope, accelerometer, satellite positioning system or various combinations of these tools may be used to determine the spatial position. A web site may be used during capture of the mentioned consolidated image, the resulting image may be presented to the user with augmented reality tools, as well as with night vision tools, for example, the thermal imager. The proposed system may be part of bionic man tools (hardware component) such as bionic eyeglasses or part of telepresence tools. In addition, the proposed system may be part of an unmanned system, e.g. an unmanned vehicle, deep sea unmanned vehicle, unmanned aerial vehicle, planetary rover.

The proposed system for video image capture includes a set of mosaic-located imaging tools 1 providing the widest field of vision. Imaging tools are a set of tools to capture dynamic images such as video images including cameras, lenses, viewfinders connected by fiber links, etc. The camera may be equipped with a set of viewfinders or with one viewfinder, which lens will have shape quite curved to provide the widest viewing angle due to optical distortion, i.e. the effect of “fish eye”. Mosaic camera location with wide field of view provides the facet vision function. In turn, the field of view maximum is determined by scientific or technical nature of the task solved with the proposed system, i.e. by need to capture images of an object or area, etc. with the required detail level. The imaging tools 1 are located remotely from the user, i.e. the user is not in direct contact with the listed tools. The imaging tools 1 are connected with a set of the image transmission and processing tools 2 that consolidate the total image from the mentioned images. The image transmission and processing tools 2 is a set of wired and/or wireless communication channels, hardware and software (servers and computers embedded in different equipment, e.g. cameras, etc.) that provide transmission of signal carrying the image from tools 1 to the personal portable user tools 3, which, in turn, display the received single total image for the user. Thus, the system to capture and send dynamic images in a wide viewing angle from the place where they are captured directly to the user is proposed.

In most cases the personal portable user tools 3 will be eyeglasses (cyber goggles) connected to the above described tools 2 of image transmission and processing. The personal portable user tools 3 will include spatial positioning tools (are not shown in the diagram) that allow to take into account and synchronize the user motion/movement with the image captured with the above described tools 1. In practice, the personal portable user tools 3 will be eyeglasses (cyber goggles) combined with a gyroscope (of different designs), an accelerometer (g-meter) and/or satellite positioning tools. The tools of image transmission and processing 2 may include the web site 4 that will be used to consolidate and to display the total image, for example, using the above mentioned eyeglasses (cyber goggles). In this case, video files captured by the tools 1 are uploaded to the web site, which provides video hosting service (e.g. YouTube service), and may be viewed using eyeglasses 3 all over the world where an Internet connection is available. In addition, the tools of image transmission and processing 2 may include tools providing the user with augmented reality (AR) objects and with images captured by night vision devices, i.e., thermal imagers or other devices providing image capture in the hours of darkness. In this case the night vision devices are used as additional tools to capture images.

In practice, the proposed system may be used as part of bionic man equipment, i.e. it may be bionic eyeglasses or similar tools. Thus, the proposed system may be used in any environment that is hard accessible for a man, for example, when servicing spacecrafts including spacewalks, landings on other planets, etc. In addition, the proposed system may be part of equipment of an unmanned system (a remotely controlled system or mobile robot), i.e. an unmanned vehicle (a robot vehicle), an unmanned deep-see vehicle, an unmanned aerial vehicle, a planetary rover (a lunar rover, mars rover, etc.). In this case the imaging tools 1 may be mounted in the unmanned vehicle, which operator will be equipped with the personal user tools 3, etc. For “everyday”, “consumer” usage the proposed system may be used as part of the telepresence tools. In this case the combination of the system tools 1, 2, 3 and/or 4 provides video streaming (video files in various formats) to broadcast online creating for different users effect of presence in the particular place: a stadium and various competitions, live artist performance in a concert, a political meeting, an extreme situation, etc.

Thus, the effective optoelectronic imaging system is proposed that may be effectively used by an individual user.

1-12. (canceled)

13. A system for capture of dynamic images comprising:
a plurality of mosaic-located cameras configured and arranged to provide a wide field of view to cover a selected area;
at least one computer configured with image transmission and processing tools to receive a plurality of images generated by the plurality of mosaic-located cameras, the at least one computer further configured to generate a single image that is a consolidation of the plurality of images, the at least one computer in electronic communication with the plurality of mosaic-located cameras;
wherein the at least one computer is further configured to provide a networked connection to a second computer, the at least one computer providing an output of the generated single image to the second computer; and
wherein the second computer is a personal portable user tool that is configured to display the generated single image, the second computer further comprising a special positioning tool configured to allow a user to determine a special position on the generated single image.

14. The system for capture of dynamic images of claim 1 wherein the special positioning tool is a gyroscope.

15. The system for capture of dynamic images of claim 1 wherein the special positioning tool is an accelerometer.

16. The system for capture of dynamic images of claim 1 wherein the special positioning tool is a satellite based global positioning system.

17. The system for capture of dynamic images of claim 1 wherein the second computer is further configured to provide an augmented reality interface.

18. The system for capture of dynamic images of claim 1 wherein the second computer further provides a night vision display.

19. The system for capture of dynamic images of claim 1 wherein the second computer is integrated into an unmanned vehicle, the unmanned vehicle being at least one of an automobile, a deep sea vehicle, an aerial vehicle, and a planetary rover.

20. The system for capture of dynamic images of claim 1 wherein the plurality of cameras are remotely located away from the at least one computer.

21. The system for capture of dynamic images of claim 1 wherein the second computer is remotely located away from the at least one computer.
